(19) United States
(12) Patent Application Publication
(10) Pub. No.: US 2010/0084589 A1
(43) Pub. Date: Apr. 8, 2010

(54) SLIDE VALVE FOR HYDRAULIC CONTROL IN A MOTOR VEHICLE AUTOMATIC TRANSMISSION

(76) Inventors: Mehmet-Fatih SEN, Hemmingen (DE); Andrzej Pilawski, Vaihingen/Enz (DE); Klaus Schudt, Nordheim (DE); Martin Pilz, Weissach Im Tal (DE); Guenther Krehl, Asperg (DE); Dirk Kube, Ludwigsburg (DE); Christof Ott, Asperg (DE)

Correspondence Address: KENYON & KENYON LLP, ONE BROADWAY, NEW YORK, NY, 10004, US

(21) Appl. No.: 12/573,189

(22) Filed: Oct. 5, 2009

(30) Foreign Application Priority Data
Oct. 6, 2008 (DE) 102008042624.5

(51) Int. Cl. F16K 3/24; F16K 31/06

(52) U.S. Cl. 251/129.01; 251/326

(57) ABSTRACT

A slide valve is used for controlling the hydraulic system in a motor vehicle automatic transmission. It includes a housing, a valve slide that is guided in the housing, which has a plurality of adjacent sections having different diameters. Furthermore, an electromagnetic operating device is provided, which is able to impinge upon the valve slide at least in a first effective direction. An impingement device impinges upon the valve slide counter to the first effective direction. It is provided that the housing has a plurality of axially set-apart passages, and that the type of functioning of the slide valve depends on the configuration of the hydraulic connections of the passages, in one configuration of the hydraulic connections, the slide valve having the functioning of a pressure control valve and/or in one configuration of the hydraulic connections, the slide valve having the functioning of a pressure reducing valve and/or in one configuration of the hydraulic connections, the slide valve having the functioning of a differential pressure valve.

### CROSS REFERENCE

The present application claims the benefit under 35 U.S.C. §119 of German Patent Application No. 102008042624.5 filed on Oct. 6, 2008, which is expressly incorporated herein by reference in its entirety.

### FIELD OF THE INVENTION

The present invention relates to a slide valve for the control of hydraulics in a motor vehicle automatic transmission.

### BACKGROUND INFORMATION

A slide valve is described in German Patent Application No. DE 199 32,747 A1. A pressure-regulating valve is described which is able to be adapted to different cases of application, in the manner of a construction kit. In particular, it is the valve slide and the housing in which the valve slide is guided that differ from application to application.

### SUMMARY

It is an object of the present invention to reduce the construction costs of motor vehicle automatic transmissions, as well as to save on space and weight.

This object may be attained by a slide valve according to the present invention. Features that may be important to the present invention are described below and are shown in the figures. The features may be important to the present invention either by themselves or in different combinations, without this being pointed out again.

According to an example embodiment of the present invention, a slide valve is provided whose central components, such as housing and valve slide are identical for all applications. The different functional types of the slide valve depend only on the configuration of the hydraulic circuit elements of the passages. The result is that the slide valve according to the present invention, even in the case of low transmission piece numbers, is able to be manufactured in comparatively large piece numbers, for subsequent installation in a transmission at different places having different functions. This applies particularly to the housing, which generally involves a cast part. Because of the increased piece numbers, manufacturing costs go down. In addition, inventory keeping is simplified, since only a single slide valve has to be kept in stock for different functional types. Furthermore, because of a reduction in the number of components, there is a saving of space and weight.

As preferred functioning types for the slide valve according to the present invention, the functionalities of a pressure control valve, a pressure reducing valve and a differential pressure valve are proposed. All three functioning types are able to be implemented using an identical slide valve, according to the present invention, and exclusively by the different hydraulic configuration. These functional types are particularly important in hydraulically operated automatic transmissions.

In view of the definition of different functionalities, the maximum flexibility is obtained if to each (hydraulically effective) diameter section of the valve slide or to each hydraulic effective area at least one passage is assigned.

For the operating safety of a motor vehicle, for example, into which a hydraulically operated automatic transmission is installed, it is important if the automatic transmission still works in case of the failure of the vehicle electrical system or in the case of the failure of the transmission control devices, that is, “emergency running properties” are made available. Therefore, each variant of the slide valve according to the present invention is particularly advantageous which has an hydraulic effective area which impinges upon the valve slide in the same first effective direction as the electromagnetic operating device and which, for example, is able to be impinged upon by the pressure prevailing at a standby control connection. In addition, this measure makes it possible to shut off the electromagnetic operating device at operating points at which reduced accuracy requirements prevail. In such a case, the slide valve may instead be operated by the hydraulic signal. In this way one is able to reduce the electrical power loss of the transmission control. This is possible in stationary operating states in which the valve slide is located in an end position.

In a further development of the present invention, it is proposed that the impingement device, that is able to impinge upon the valve slide, counter to the first operating direction, includes a pin guided in the housing, whose one end includes an hydraulic effective area and whose other end lies against the valve slide, the hydraulic effective area being also connected to the hydraulic standby control connection. In functional type “pressure control valve,” this permits setting a comparatively high limiting or system pressure.

Different pressure levels occur in different transmissions and in different functional types of a slide valve. In this case, in order also to be able to use the slide valve according to the present invention, without making changes in the valve slide or the housing, an adaptation is proposed to the individual use situation by a spring impinging upon the valve slide, whose initial stress is able to be set, for example, by a spring retainer that is easy to position with respect to the housing, for instance, by compression or a screw joint. This measure thus broadens the areas of application of the slide valve according to the present invention, in a simple and inexpensive way.

Another example embodiment of the slide valve provides that, on the one hand, an hydraulic annular area is provided in the first effective direction and, on the other hand, a pin is provided that acts counter to the first effective direction and is impinged upon hydraulically, this pin having been mentioned above in a another connection. The latter may also be called a “sensor pin”. Because of the hydraulic effective area of the pin and the annular area, a hydraulic equilibrium is established (pressure difference regulation) or rather, the hydraulic force level is adjusted to the force level of the electromagnetic operating device. Thereby, very high pressures, that occur, for instance, in connection with CVT automatic transmissions, are also able to be managed at good accuracy. A comparatively small electromagnetic operating device may be used in this context, without a reinforcement slide being required in response to a “one stage” embodiment of the slide valve.

In addition, the use of a pin permits a very simple and cost-effective adaptation of the slide valve to different pressure ranges, by the variation in the pin's diameter.

Two quite specific embodiments of the slide valve according to the present invention are also provided, which unify the three functional types pressure control valve, pressure reducing valve and differential pressure valve among themselves in an especially simple manner, constructively speaking.

A specific embodiment of the present invention is explained in exemplary fashion below, with reference to the figures.

### BRIEF DESCRIPTION OF THE DRAWINGS

FIG. 1 shows a schematic representation of an automatic transmission and an associated hydraulic circuit having three slide valves which are made identically, of which, however, one works like a pressure control valve, one as a pressure reducing valve and one as a differential pressure valve.

FIG. 2 shows a partial section through a first specific embodiment of the pressure control valve in FIG. 1.

FIG. 3 shows a partial section through a first specific embodiment of the pressure reducing valve in FIG. 1.

FIG. 4 shows a partial section through a first specific embodiment of the differential pressure valve in FIG. 1.

FIG. 5 shows a partial section through a second specific embodiment of the pressure control valve in FIG. 1.

FIG. 6 shows a partial section through a second specific embodiment of the pressure reducing valve in FIG. 1.

FIG. 7 shows a partial section through a second specific embodiment of the differential pressure valve in FIG. 1.

### DETAILED DESCRIPTION OF EXAMPLE EMBODIMENTS

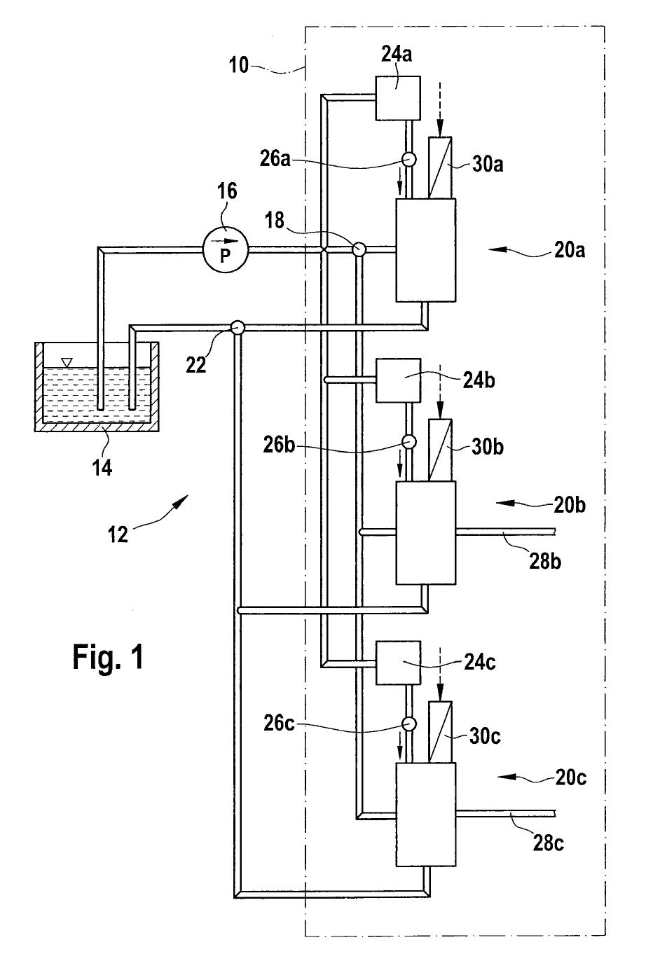

An automatic transmission of a motor vehicle is shown in FIG. 1 by a dashed and dotted box, and it bears the reference numeral 10, overall. A hydraulic circuit 12 is provided for controlling automatic transmission 10, to which a pressureless hydraulic reservoir 14 and a hydraulic pump 16 belong. An outlet of hydraulic pump 16 forms a supply terminal 18, to which three slide valves 20a, 20b and 20c are connected. Slide valve 20a operates as a pressure control valve, system pressure P being able to be set inversely proportional the specified electromagnetic force, slide valve 20b operates as a pressure reducing valve, the pressure at the working connection being able to be set proportional to the specified electromagnetic force, and slide valve 20c operates as a differential pressure valve, the differential pressure between the inlet and the working connection being able to be set inversely proportional to the specified electromagnetic force. The three slide valves 20a-20c are generally identical, and, as will be stated in detail below, their different functions are implemented, above all, by a different hydraulic configuration.

From each slide valve 20a-20c, a return line runs to a return line connection 22, which returns to hydraulic reservoir 14. In addition, a hydraulic control device 24a-24c is assigned to each slide valve 20a-20c, and it is connected to a respective standby control connection 26a-c of a slide valve 20a-c. the two slide valves 20b and 20c in addition have a working connection 28b and 28c. Besides, each slide valve 20a-20c has an electromagnetic operating device 30a-30c.

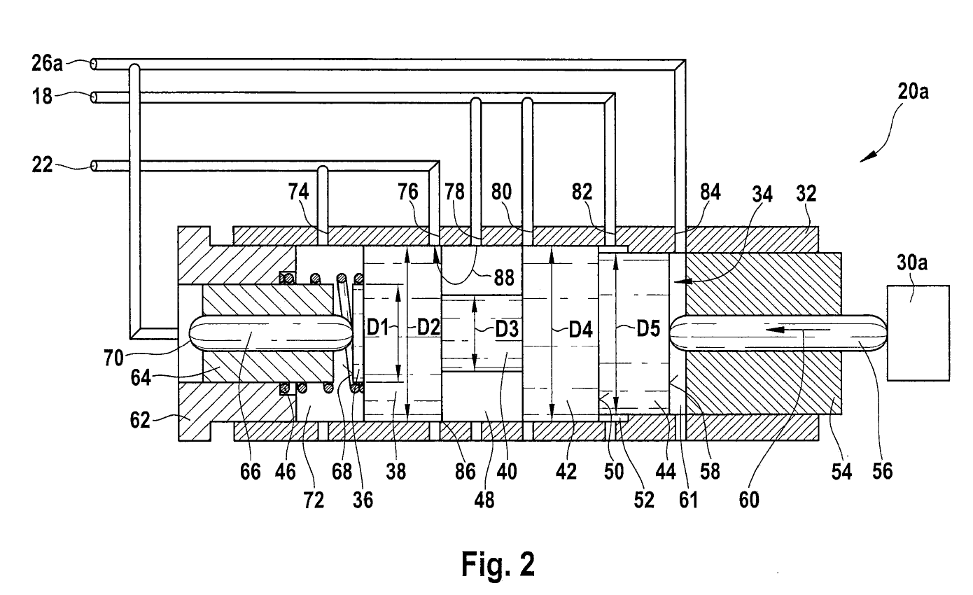

Slide valve 20a, having the function of a pressure control valve, is designed in the following manner, in a first specific embodiment (FIG. 2): Slide valve 20a includes a sleeve-like housing 32, in which a stepped piston-like valve slide 34 is guided. As seen in FIG. 2 from left to right, valve slide 34 has altogether five sections 36 to 44. The farthest left diameter section 36 has a diameter D1 and is used as the centering section for a valve spring 46. The first diameter section 38, that is hydraulically relevant, has a diameter D2, which is clearly greater than diameter D1, and it is guided in a fluid-tight manner in housing 32. The subsequent, second hydraulically relevant diameter section 40 has a diameter D3, which is clearly less than diameter D2. An annular space 48 is present between section 40 and housing 32. The third hydraulically relevant diameter section 42, that now follows, has a diameter D4, which is equal to diameter D2. It is also guided in a fluid-tight manner in housing 32. All the way over to the right in FIG. 2 is fourth hydraulically relevant diameter section 44, which has a diameter D5 that is somewhat smaller than diameter D4. An annular area 50 is formed by this, between sections 42 and 44. Section 44 is also guided in housing 32 in a fluid-tight manner, at least over one axial subsection, which is implemented by a housing section (not having a reference number) having a slightly reduced inside diameter compared to the remaining housing range. In this way, an annular space 52 is formed in the vicinity of annular area 50, between section 44 and housing 32.

At the right end of FIG. 2, housing 32 is closed by a guide piece 54, in which an operating pin 56 is guided. The one end of operating pin 56 lies against an end face 58 of valve slide 34, and the other end is connected to operating device 30a. In this way, electromagnetic operating device 30a is able to impinge upon valve slide 34 in a first effective direction (arrow 60). Between right end face 58 of valve slide 34, in FIG. 2, and guide piece 54, a standby pressure chamber 61 is formed, whose function will be discussed below.

At its left end in FIG. 2, a plug-like insert piece 62 is press-fit into housing 32, on which valve spring 46 is supported, and in this respect forms a spring retainer. The prestressing of valve spring 46 is set to a desired value by an appropriate positioning of insert piece 62 relative to housing 32. A bearing block 64 is press-fit into insert piece 62, in which a force transmission pin 66, also designated as a “sensor pin” is supported in a fluid-tight and sliding manner. The latter lies with its one end against left end face 68, in FIG. 2, of valve slide 34. The other end of force transmission pin 66 forms a hydraulic effective area 70. Between the end face of valve slide 34 at the left in FIG. 2, insert piece 62, bearing block 64 and housing 32, a low pressure chamber 72 is formed.

A plurality of radial passages 74-84 is present in housing 32. The “zeroth” passage 74 is located in the region of low pressure chamber 72, first passage 76 in the region of first section 38 of valve slide 34, second passage 78 in the region of second section 40, third passage 80 in the region of third section 42, fourth passage 82 in the region of fourth section 44, and fifth passage 84 in the region of standby pressure chamber 61. Passages 74 and 84 may be hydraulically connected in a different way. In order to implement a pressure control valve, as shown in FIG. 2, passages 74 and 76 are connected to return flow connection 22, passages 78, 80 and 82 are connected to supply terminal 18 and passage 84 is connected to standby control connection 26a. In addition, hydraulic effective area 70 of force transmission pin 66 has applied to it the pressure made available at standby control connection 26a, whereby the force at annular area 50 is able to be adjusted to the desired pressure characteristic. In the case of this hydraulic connection, a control edge 86 is formed between diameter sections 38 and 40, by which, depending on the setting of valve slide 34, passage 76 is controlled to be more or less free. In a specific embodiment not shown, passage 76 could be connected, not to return flow connection 22, but rather to a lubricant pressure connection. Effective areas 50 and 70 could be designed so that, at passage 76, a reduced pressure is always present that is substantially smaller than the supply pressure is, and essentially corresponds to the typical pressure required for lubricating the parts that are movable relative to one another.

Pressure control valve 20a shown in FIG. 2 operates with the following balance of forces (the subscripts designate the respective hydraulic effective forces and electromagnetic operating device 30a and valve spring 46):

F₅₀+F₃₀ₐ+F₅₈−F₇₀−F₆₈−F₄₆=0.

The pressure to be controlled at supply terminal 18 acts, on the one hand, upon hydraulic effective area 70 at force transmission pin 66 and, on the other hand, on annular area 50. The latter is shown by the difference in diameters between sections 42 and 44 of valve slide 34. The pressure force created is adjusted in force level via the pressure force created at hydraulic effective area 70 to the force level of electromagnetic operating device 30a. At this time, we should point out that the pressure level of pressure control valve 20a is able to be adjusted to the specific requirements and to the force level of electromagnetic operating device 30a via the diameter of force transmission pin 66. Force transmission pin 66 and corresponding bearing block 64 thus may differ from case to case. It should also be noted that, in chamber 72 a comparatively low pressure prevails, and force F₆₈ is thus also comparatively low, and is therefore often set equal to zero, in practice.

In the case of a purely hydraulic operation, that is, in the case of a deactivated electromagnetic operating device 30a, or one that is not working because of interference, hydraulic control device 24a provides a pressure signal as a function of the operating point at standby control connection 26a. This pressure signal is converted to a force F₅₈ via end face 58 of valve slide 34, that corresponds to the force range of electromagnetic operating device 30a. Thereby, slide valve 20a is able to be operated at restricted accuracy, even without functioning electromagnetic operating device 30a.

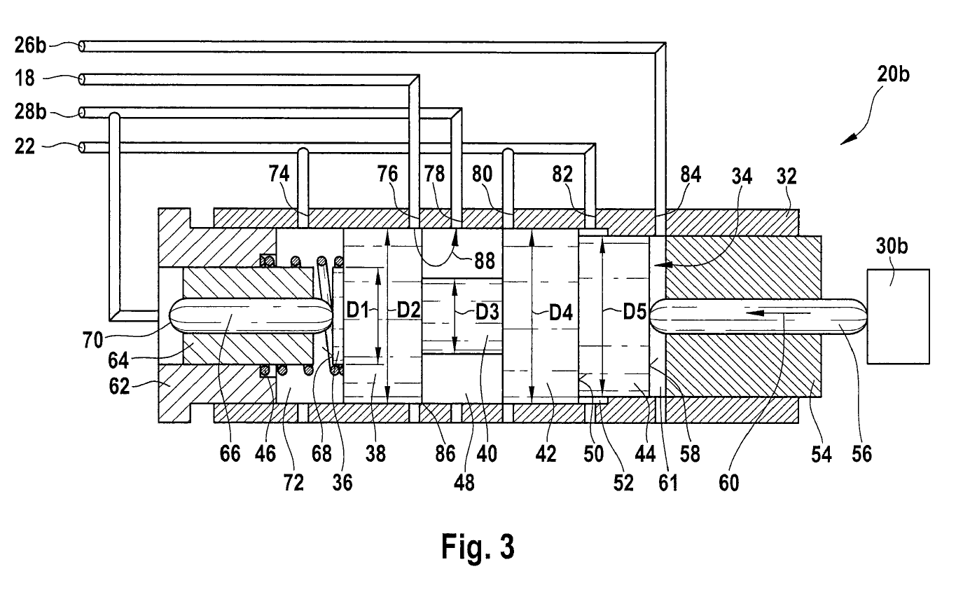

FIG. 3 shows pressure reducing valve 20b in a first specific embodiment. Elements and regions whose functions are equivalent to elements and regions already described, in this context, bear the same reference symbols, both here and in the following text. We shall not concern ourselves with them in detail again.

One may see in FIG. 3, that pressure reducing valve 20b is basically designed to be completely identical to pressure control valve 20a. The different functioning is basically achieved only by a different hydraulic connection of passages 74-84. Passages 74, 80 and 82 are connected to return flow connection 22, passage 76 is connected to supply terminal 18, passage 78 and hydraulic effective area 70 are connected to working connection 28b and passage 84 is connected to standby control connection 26b. Pressure reducing valve 20b works at the following pressure balance:

F₇₀+F₆₈+F₄₆−F_{30b}−F₅₀−F₅₈=0.

Here too, because of control edge 86, passage 76 is covered more or less, depending on the position of valve slide 34 relative to housing 32, and the pressure reducing effect is controlled thereby. The corresponding hydraulic flow in pressure reducing valve 20b is opposite to the one in pressure control valve 20a in FIG. 2 (arrow 88). The pressure range is established at a specified electromagnetic operating device 30b by the diameter of force transmission pin 66. In this context, large diameters lead to a small pressure range, and small diameters lead to a large pressure range. Force transmission pin 66 is a rotationally symmetrical part, which is able to be produced with high accuracy, in a cost-effective manner. This leads to a very good control accuracy. It applies here too, that the pressure in chambers 72 and 52 and the corresponding forces F₆₈ and F₅₀ are comparatively low, and are often set equal to zero in practice.

Here too, in the case of a purely hydraulic operation, that is, in the case of a deactivated electromagnetic operating device 30a, or one that is not working because of interference, hydraulic control device 24a provides a pressure signal as a function of the operating point at standby control terminal 26a. This pressure signal is converted to a force F₅₈ via end face 58 of valve slide 34 that corresponds to the force range of electromagnetic operating device 30a. Thereby, slide valve 20a is able to be operated at restricted accuracy, even without functioning electromagnetic operating device 30a.

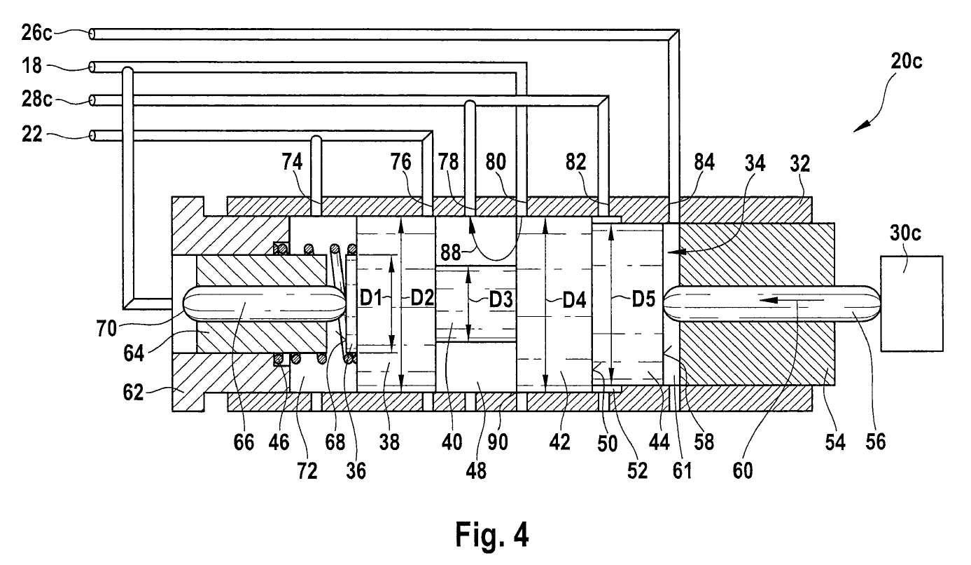

FIG. 4 shows differential pressure valve 20c in a first specific embodiment.

In FIG. 4 one may see without difficulty that differential pressure valve 20c is designed to be identical to the two valves 20a and 20b. The general difference from valves 20a and 20b relates, in turn, in the first place to the hydraulic connections of passages 74-84. Passages 74 and 76 are connected to return flow connection 22, passages 78 and 82 are connected to working connection 28c, passage 80 and hydraulic effective area 70 of force transmission pin 66 are connected to supply terminal 18, and passage 84 is connected to standby control terminal 26c. In the case of differential pressure valve 20c, a control edge 90 is formed by the sudden diameter change between sections 40 and 42, which controls the hydraulic stream flowing through passage 80. Differential pressure valve 20b works at the following pressure balance:

F₇₀+F₄₆+F₆₈−F₅₀−F_{30c}−F₅₈=0.

The least pressure difference is able to be adjusted by the ratio of hydraulic effective area 70 to annular area 50. The pressure difference may be set according to the absolute quantity because of the force of electromagnetic operating device 30c.

In the case of a purely hydraulic operation, that is, in the case of a deactivated electromagnetic operating device 30a, or one that is not working because of interference, hydraulic control device 24a provides a pressure signal as a function of the operating point at standby control terminal 26a. This pressure signal is converted to a force F₅₈ via end face 58 of valve slide 34 that corresponds to the force range of electromagnetic operating device 30a. Thereby, slide valve 20a is able to be operated at restricted accuracy, even without functioning electromagnetic operating device 30a.

One may recognize that the three slide valves 20a-20c of FIGS. 2-4 are structurally almost identical. The different functionality is produced by the corresponding configuration of the hydraulic connection of passages 74-84. The adjustment to the pressure level desired in each respective case of application is accomplished by the selection of an appropriate diameter for force transmission pin 66 and the selection of valve spring 46. Pressure control valve 20a is provided with a valve spring 46 having a relatively high stiffness, which acts counter to the effective direction of electromagnetic operating device 30a. The pressure reducing valve has a valve spring 46 having a comparatively low stiffness, and in differential pressure valve 20c no valve spring at all is installed.

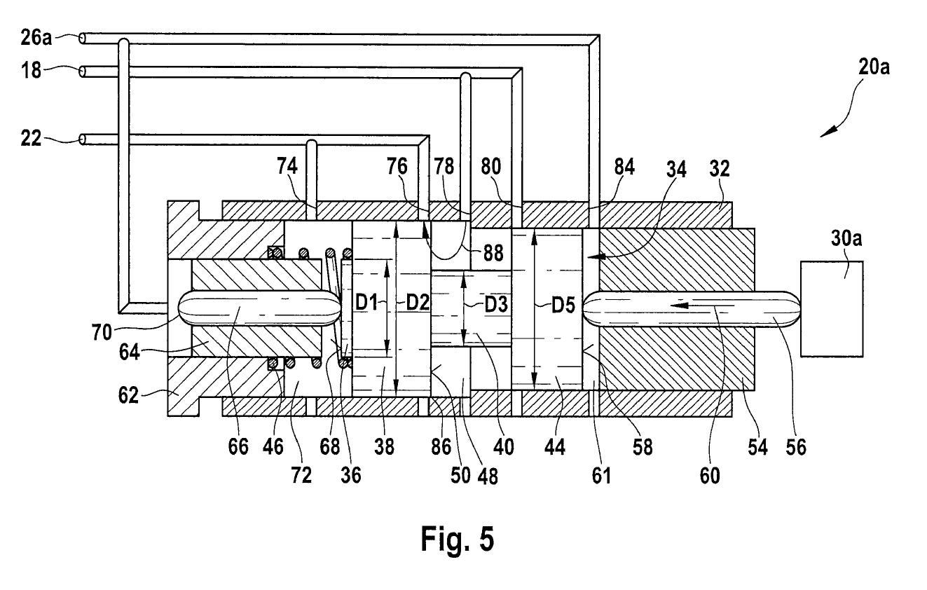

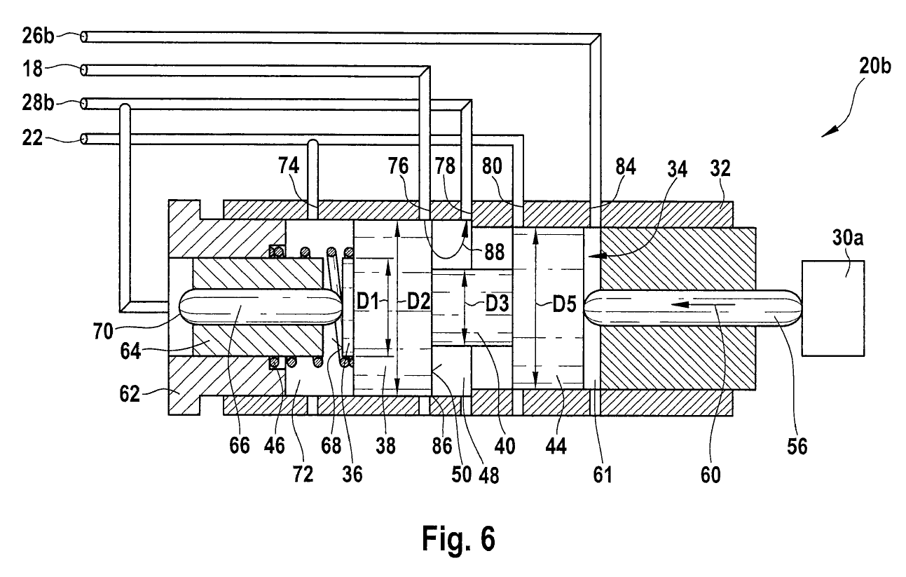

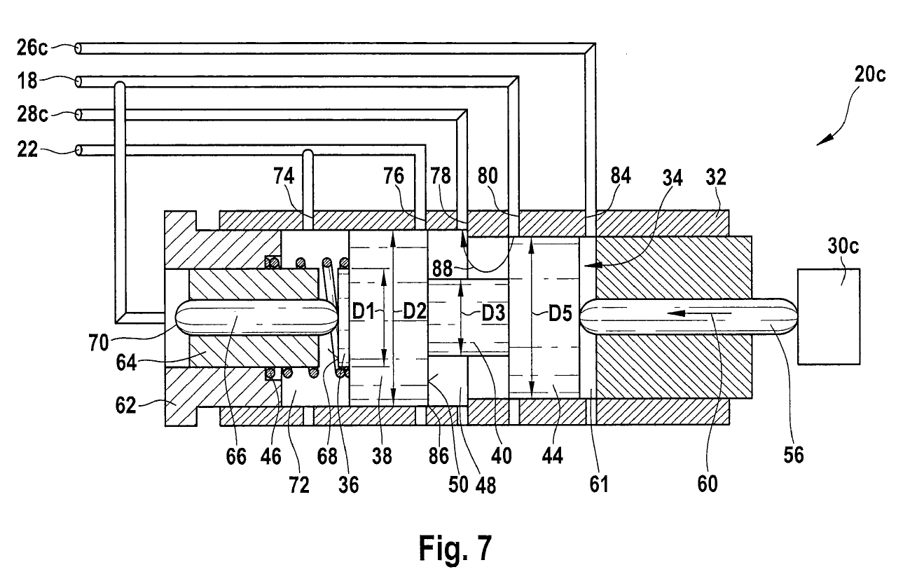

Second specific embodiments of the pressure control valve, the pressure reducing valve and the differential pressure valve of FIG. 1 are shown in FIGS. 5 through 7. It applies here too, that elements and regions, which are functionally equivalent to the elements and regions described above, bear the same reference symbols and are not once more explained in detail. The same also applies for functionalities already described above, which are not explained once more in detail.

In the second specific embodiment, the sudden diameter change between the third and the fifth diameter section is omitted, and thus also the corresponding annular area. Consequently, there come about only three hydraulically effective diameter sections 38, 40, 44 and passages 76-80 associated with them. The design of valve slide 34 becomes simplified thereby, one connection (reference numeral 82 in FIGS. 2 to 4) is omitted, and the entire valve 20a to 20c is constructed to be smaller.

The hydraulic effective area important for its functioning comes about from the different diameters D2 and D5 of diameter sections 38 and 44. This hydraulic effective area is indicated in FIGS. 5 to 7 by reference numeral 50, to be sure, but it should be pointed out at this stage that this does not involve an unequivocally delimited effective area, but involves the area difference by which the annular end face of diameter section 38, that delimits annular chamber 48, is greater than the annular end face of diameter section 44 that lies opposite and also borders on annular chamber 48. This difference in area generates a force F₅₀, at valve slide 34, which is aligned in the same direction to the force of electromagnetic operating device 30a, 30b and 30c.

In the hydraulic connections shown in FIGS. 5 to 7, the same balances of forces apply, as well as the same functioning principles and alternatives as in the variants of FIGS. 2-4.

What is claimed is:

1. A slide valve for controlling a hydraulic system in a motor vehicle automatic transmission, comprising:
a housing;
a valve slide guided in the housing, the valve slide having a plurality of adjacent sections having different diameters, and a plurality of axially set-apart passages;
an electromagnetic operating device which is adapted to impinge upon the valve slide at least in a first effective direction; and
an impingement device which is adapted to impinge upon the valve slide counter to the first effective direction;
wherein a functioning type of the slide valve depends on a configuration of hydraulic connections of the passages, at least one of: i) in one configuration of the hydraulic connections, the slide valve functioning as a pressure control valve, ii) in one configuration of the hydraulic connections, the slide valve functioning as a pressure reducing valve, and iii) in one configuration of the hydraulic connections, the slide valve functioning as a differential pressure valve.

2. The slide valve as recited in claim 1, wherein at least one of the passages is assigned to each diameter section of the valve slide.

3. The slide valve as recited in claim 1, wherein the slide valve has a hydraulic effective area which acts in the first effective direction and to which one of the passages in the housing is assigned, which is connected to a hydraulic standby control connection.

4. The slide valve as recited in claim 3, wherein the impingement device includes a pin guided in the housing, a first end of the pin including a hydraulic effective area and a second end of the pin lying against the valve slide, the hydraulic effective area being also connected to the hydraulic standby control connection.

5. The slide valve as recited in claim 1, wherein the impingement device includes a spring which is stressed between a spring retainer on a side of the housing and the valve slide, and the spring retainer is situated relative to the housing in such a way that a prestressing of the spring is obtained.

6. The slide valve as recited in claim 1, wherein the valve slide includes an annular hydraulic effective area acting in the first effective direction and the impingement device includes a pin guided in the housing, the pin having a first end which includes an hydraulic effective area and a second end which lies against the valve slide.

7. The slide valve as recited in claim 6, wherein a diameter of the pin is selected to be a function of the operating pressure of the slide valve.

8. The slide valve as recited in claim 6, wherein the valve slide, in a first direction counter to the first effective direction, has a first diameter section having a first diameter, has a second diameter section having a second diameter, which is smaller than the first diameter, has a third diameter section, having a third diameter that is greater than the second diameter, and has a fourth diameter section having a fourth diameter that is smaller than the third diameter, the first and the third diameter sections being completely guided, and the fourth diameter section being guided over a part of its axial length, in the housing in a fluid-tight manner, in such a way that, when a first passage assigned to the first diameter section is connected to a return flow connection, and second to fourth passages assigned to the second to fourth diameter sections are connected to a supply terminal, the slide valve functions as a pressure control valve; and when the first passage is connected to the supply terminal, the second passage and the hydraulic effective area of the pin are connected to a working connection, and the third passage and the fourth passage are connected to a return flow connection, the slide valve functions as a pressure reducing valve, and when the first passage is connected to the return flow connection, the second passage and the fourth passage are connected to the working connection, and the third passage and the hydraulic effective area of the pin are connected to a supply terminal, the slide valve functions as a differential pressure valve.

9. The slide valve as recited in claim 6, wherein the valve slide, in a direction counter to the first effective direction, has a first diameter section having a first diameter, has a second diameter section having a second diameter which is smaller than the first diameter, and has a third diameter section having a third diameter that is greater than the second diameter and smaller than the first diameter, the first and the third diameter sections being guided in the housing in a fluid-tight manner, in such a way that, when a first passage assigned to the first diameter section is connected to a return flow connection, and the second and third passages assigned to the second the third diameter sections are connected to a supply terminal, the slide valve functions as a pressure control valve, and when the first passage is connected to the supply terminal, the second passage and the hydraulic effective area of the pin are connected to the working connection, and the third passage is connected to the return flow connection, the slide valve functions as a pressure reducing valve, and when the first passage is connected to the return flow connection, the second passage is connected to the working connection and the third passage and the hydraulic effective area of the pin are connected to the supply terminal, the slide valve functions as a differential pressure valve.
